(19) United States
(12) Patent Application Publication
(10) Pub. No.: US 2012/0016721 A1
(43) Pub. Date: Jan. 19, 2012

(54) Price and Utility Optimization for Cloud Computing Resources

(76) Inventor: Joseph Weinman, Basking Ridge, NJ (US)

(21) Appl. No.: 12/836,968

(22) Filed: Jul. 15, 2010

(51) Int. Cl. G06Q 10/00; G06F 15/173

(52) U.S. Cl. 705/7.35; 709/223; 718/102

(57) ABSTRACT

Methods, systems, and computer-readable media for optimizing the utilization of a resource of a cloud service provider based on variable pricing strategies are presented herein. According to one aspect, a method for optimizing the utilization of a resource of a cloud service provider includes receiving a time-based price schedule that includes a price for utilizing the resource during a specific time period. The method also includes receiving a job request associated with a job request execution criteria. Based on the job request execution criteria and the price for utilizing the resource during the specific time period, the job request is matched with the resource. Once the job request and the resource are matched, the job request is sent to the cloud service provider of the resource for execution.

### TECHNICAL FIELD

Exemplary embodiments are related to the utilization of cloud computing resources. In particular, exemplary embodiments relate to optimizing the price and utilization of cloud computing resources from one or more cloud service providers.

### BACKGROUND

Cloud computing in general is becoming increasingly popular. In particular, infrastructure as a service (“IAAS”), which is an aspect of cloud computing in which computer resources may be rented for utilization from cloud service providers at low prices, is gaining popularity. In this way, a client may not need to make a large capital expenditure to purchase computer infrastructure that the client may have incurred prior to the advent of cloud computing.

At present, various cloud service providers either have fixed prices for infrastructure services, e.g., a dollar per server hour, or provide spot (current, real-time) pricing to set prices for utilizing computing resources at various times of the day. Spot pricing involves setting a fixed price for renting a computing resource for a fixed time interval. Because the prices are fixed, the computing resource is only utilized if a company is willing to pay the asking price of the cloud service provider. This may result in computing resources being left unutilized. Computing resources may be considered to be perishable commodities that lose their value if left unutilized. Accordingly, cloud service providers need a more efficient pricing strategy that improves the utilization of computing resources in order to maximize their profit. In addition, cloud service customers need a more efficient way to determine which jobs should be executed at which time based on the prices provided by one or more cloud service providers.

### SUMMARY

Embodiments of the disclosure presented herein include methods, systems, and computer-readable media for optimizing the utilization of a resource of a cloud service provider based on variable pricing strategies. According to one aspect, a method for optimizing the utilization of a resource of at least one cloud service provider includes receiving a time-based price schedule that includes one or more prices for utilizing the resource during each of one or more specific time periods. The method also includes receiving a job request associated with one or more job request execution criteria. Based on the job request execution criteria and the price for utilizing the resource during the specific time period, the job request is matched with the resource. Once the job request and the resource are matched, the job request is sent to the cloud service provider of the resource for execution.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 illustrates a cloud provider system and a consumer system communicating over a network, according to various embodiments;

FIG. 2A illustrates a matching system communicating with a plurality of cloud provider systems and a plurality of consumer systems, according to various embodiments;

FIG. 2B is a block diagram illustrating aspects of the matching system communicating with a cloud provider system and a consumer system, according to various embodiments;

FIG. 3 illustrates exemplary pricing tables containing price schedules and an exemplary job list table containing job request entries, according to various embodiments;

FIG. 4 is a logical flow diagram illustrating aspects of a process for creating a price schedule and executing a job request, according to various embodiments;

FIG. 5 is a logical flow diagram illustrating aspects of a process for matching a job request with one or more of the resources via the matching system, according to various embodiments; and

FIG. 6 is a block diagram illustrating an exemplary computer system configured to optimize the utilization of resources of a cloud service provider, according to various embodiments.

### DETAILED DESCRIPTION

The following detailed description is directed to methods, systems, and computer-readable media for optimizing the utilization of a resource of one or more cloud service providers based on variable pricing strategies. Through the implementation of the present disclosure, clients can extract optimal value for the amount they pay for utilizing resources of cloud service providers, while cloud service providers can optimize their resource utilization.

As described above, cloud service providers presently utilize fixed pricing and spot pricing, which involves setting a fixed price for renting a computing resource of the cloud service provider for a fixed time interval. Although the price for a fixed time interval may vary depending upon the time of the day or the day of the week, the price is usually pre-set and does not dynamically change based on resource utilization. By way of the present disclosure, cloud service providers may be able to utilize dynamic pricing, where the price of utilizing resources may vary over time based on resource availability. With flexible pricing, clients may have the potential to afford utilizing resources of the cloud service provider for jobs that have very small budgets.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration, specific embodiments, or examples. Referring now to the drawings, like numerals will represent like elements through the several figures. For the sake of ease of understanding, details pertaining to embodiments of the present disclosure will be explained by way of specific examples.

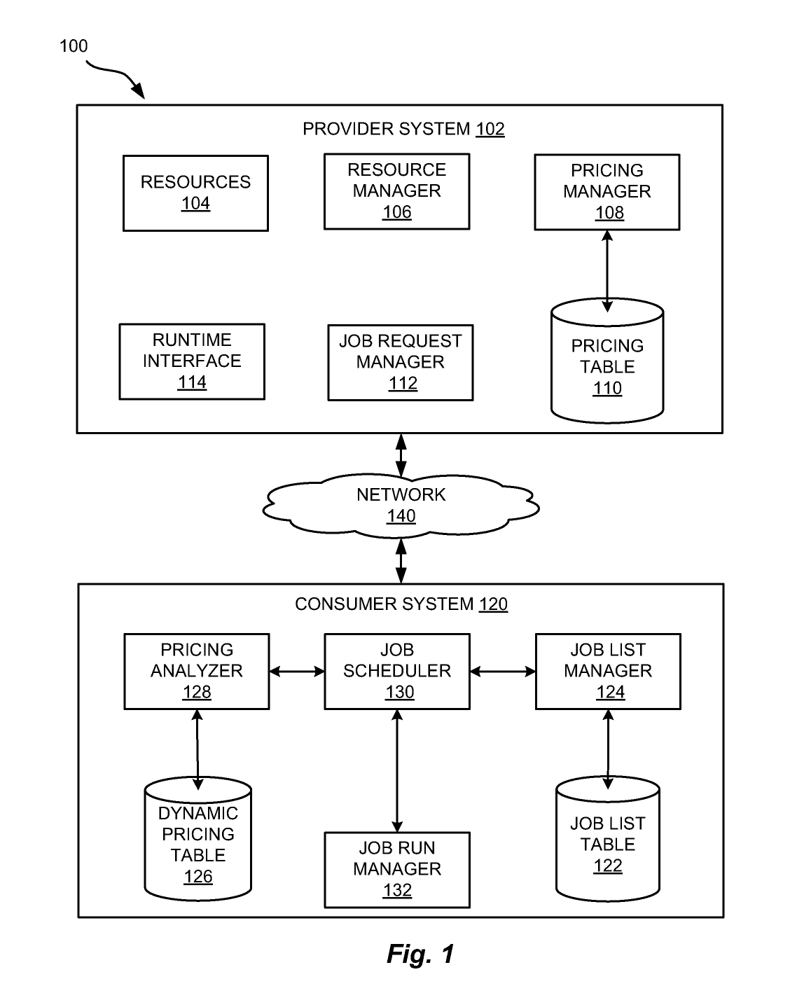

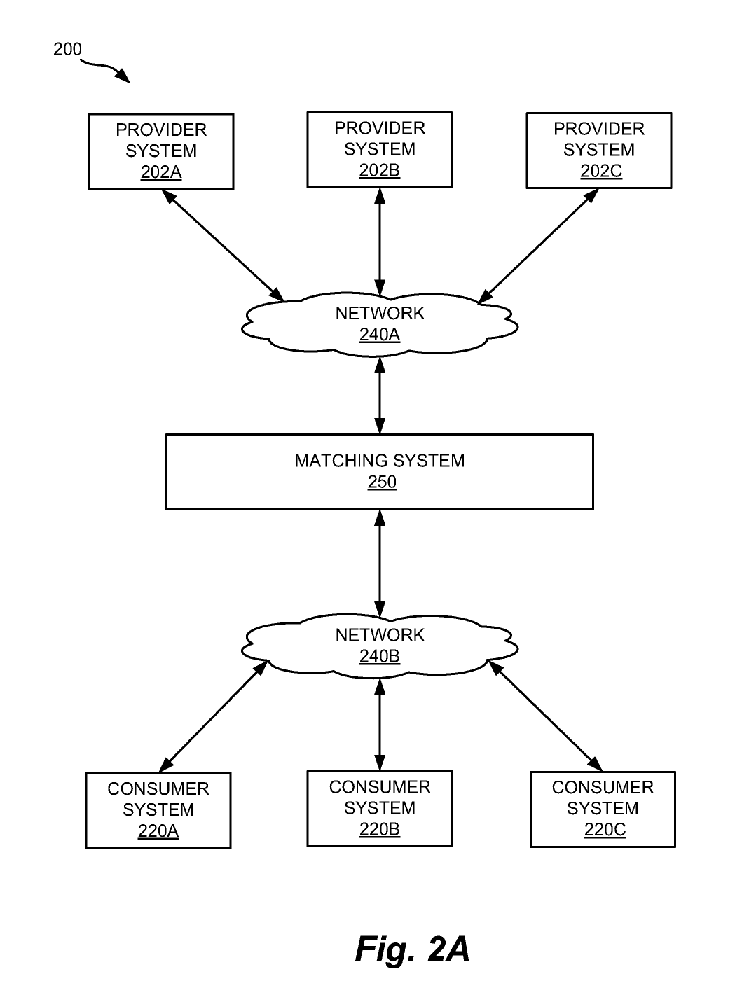

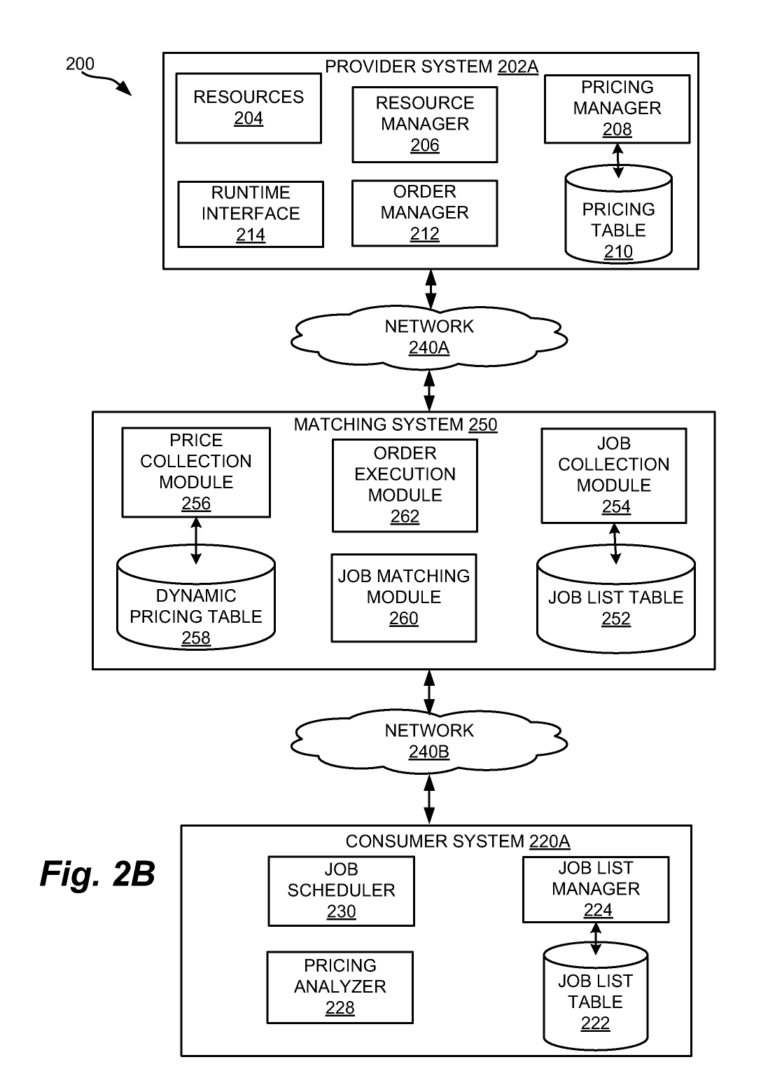

FIG. 1 illustrates an environment 100, where a cloud provider system 102 and a consumer system 120 are communicating over a network 140, according to embodiments described herein. The cloud provider system 102 may provide cloud computing services to one or more of the consumer systems 120. These cloud computing services may include Infrastructure as a service (“IAAS”), which may include the utilization of resources, such as storage, servers, processing capabilities, and the like. Although FIG. 1 illustrates one cloud provider system 102 and one consumer system 120, it should be appreciated that one or more cloud provider systems may communicate with one or more consumer systems. In such embodiments, one of which is shown in FIGS. 2A and 2B, a matching system 250 may operate as a broker between the multiple cloud provider systems and the multiple consumer systems.

Still referring to FIG. 1, the cloud provider system 102 may include resources 104, a resource manager 106, a pricing manager 108, a pricing table 110, a job request manager 112 and a runtime interface 114. The cloud provider system 102 may be a combination of both hardware components and software components. According to various embodiments, the resource manager 106, pricing manager 108 and the job request manager 112 may be software modules, sub-modules, or any other piece of software. The pricing table 110 may be stored on the cloud provider system 102 or on a separate storage device that is in communication with the cloud provider system 102.

The resources 104 may include one or more storage disks, servers, virtual servers, local area networks, firewalls, load balancers, virtual private network (“VPN”) appliances, central processing units (“CPUs”), or other resources that the cloud provider system 102 is capable of providing to one or more of the consumer systems 120. It should be appreciated that the resources 104 may include one or more resources that do not reside within the cloud provider system 102 but may be under the control of the cloud provider system 102. According to various embodiments, the resources 104 may be directly or indirectly connected with one another.

The cloud provider system 102 may also include the resource manager 106, which may be configured to manage the resources 104 of the cloud provider system 102. The resource manager 106 may maintain relevant information related to the resources 104. In particular, the resource manager 106 may maintain information regarding the availability and utilization of the resources 104, the current states of the resources 104, the type of resources 104, configuration information, as well as any meta-data associated with the resources 104. According to embodiments, the resource manager 106 may be configured to determine the availability of the one or more resources 104 of the cloud provider system 102. In addition, the resource manager 106 may be configured to monitor the health of the one or more resources 104 according to methods well known in the art.

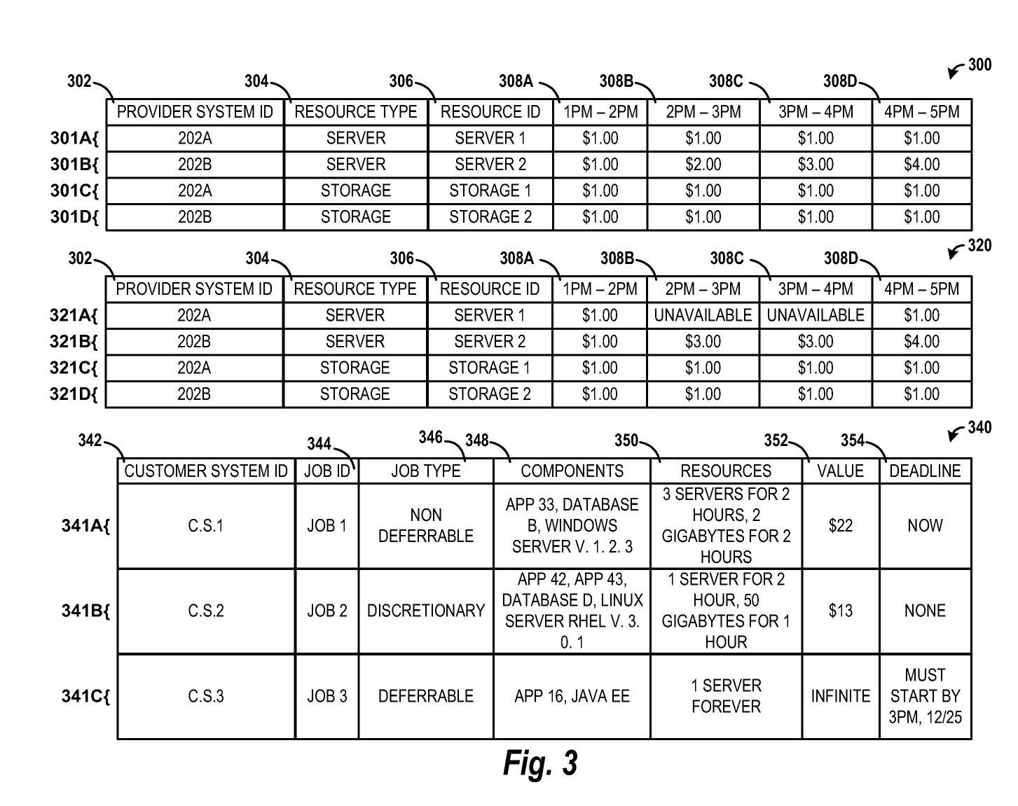

The cloud provider system 102 may also include the pricing manager 108, which may be configured to generate one or more price schedules that indicate prices for utilizing the one more resources 104 of the cloud provider system 102. The price schedules may be stored in the pricing table 110. According to embodiments, the pricing manager 108 may generate a price schedule for each of the resources 104 or alternatively, a price schedule for each type of resource. For instance, if the resources 104 include two storage disks, three servers and four CPUs, the pricing manager 108 may generate a separate price schedule for each of the two storage disks, multiple price schedules for virtualized partitions of the disks, or one price schedule for the two storage disks. However, it should be appreciated that having separate price schedules for each of the two storage disks or even more granular partitions of each of the two storage disks, allows the cloud provider system 102 to have more flexibility in pricing its resources. This will become more apparent during a discussion of an exemplary pricing table shown in FIG. 3.

The pricing manager 108 may be configured to set prices for utilizing the resources by analyzing various types of information, such as information related to the current and forecasted utilization and availability of the resources 104, historical price and utilization information of the resources 104, competitor pricing information, and forecasted resource demand information. Additionally, the pricing manager 108 may be configured to dynamically adjust the prices for utilizing the one or more resources 104. Details regarding dynamically adjusting the prices will be described in further detail below.

The pricing table 110 may be stored on a storage device, such as a hard disk, memory, or any other storage device. The pricing table 110 may include the one or more price schedules generated by the pricing manager 108. Each price schedule may indicate prices for utilizing the resources 104 of the cloud provider system 102 for one or more time intervals. The price schedule may include information, such as a type of resource, a location of the resource, a resource identifier, and one or more prices for utilizing the resource over one or more time periods. Additional pricing tables 300 and 320 illustrated in FIG. 3 show examples of price schedules for exemplary resources of a cloud provider system, as discussed further below.

The pricing manager 108 may be configured to update the pricing table 110 including the one or more price schedules for the resources 104. The pricing table 110 may be updated upon a change in the availability of resources of the cloud provider system 102 or due to other factors, such as competitors' prices for similar types of resources. Further, it should also be appreciated that a price schedule may have an expiration date associated with the price schedule. The expiration date may be a specific time that is pre-defined by the pricing manager 108, an instant when an update to that price schedule is received at the pricing table 110 from the pricing manager 108, or any other instant at which the cloud provider system 102 decides the price schedule is no longer valid. Once the expiration date associated with the price schedule is passed, the price schedule is no longer valid and the pricing manager 108 may generate a new price schedule.

The pricing table 110 may be accessible by the consumer system 120. According to embodiments, the pricing table 110 may be accessed by the consumer system 120, through the network 140 via an application network interface. Examples of an application network interface may include SOAP/XML, JSON, a remote procedure call, screen scraping from an externally viewable web page, and the like. In this way, the consumer system 102 may be able to retrieve the price schedules stored in the pricing table 110.

The cloud provider system 102 may also include the job request manager 112 that may also be configured to communicate with the consumer system 120 via the same application network interface used to provide the consumer system 120 access to the pricing table 110 or via a different application network interface. The job request manager 112 may be configured to receive one or more job requests from the consumer system 120. A job request may be a request to utilize the resources 104 of a cloud provider system. Each job request may be associated with a job request execution criteria. Generally, the job request execution criteria may include a set of rules under which the job request should be executed. Specifics regarding the job request execution criteria are described in further detail below.

Once the job request manager 112 receives the job request and the associated job request execution criteria, the job request manager 112 then matches the one or more resources 104 capable of executing each job request with the job request according to the associated job request execution criteria. Once the job request manager 112 matches the one or more resources 104 with the job request, the resource manager 106 may update the availability of the resources 104. The pricing manager 108 may subsequently update the pricing table 110 by updating the price schedules of the one or more resources 104. According to embodiments, the pricing manager 108 may update the pricing table 110 to increase the price of the resource 104 matched with the job request since current availability of the resource has diminished. In addition, the pricing manager 108 may also increase the price for utilizing resources that are similar to the matched resource since the availability of that particular type of resource has been diminished.

The job request manager 112 may be configured to manage the job requests received from the consumer system 120. A discussed above, managing the job requests may include matching the one or more job requests to one or more of the resources 104 of the cloud provider system 102. In addition, the job request manager 112 may maintain a database containing each job request, the one or more resources 104 with which the job request is matched, the price at which the job request will be executed, the time at which the job request will begin to execute, the duration for which the resources will be utilized, and the like. Further, the job request manager 112 may generate execution instructions for those job requests that are matched with one or more of the resources 104 of the cloud provider system 102. These execution instructions may also be stored in the database maintained by the job request manager 112.

The cloud provider system 102 may also include the runtime interface 114. The runtime interface 114 may be configured to execute the job requests according to the execution instructions generated by the job request manager 112. This may entail deploying the job request to the appropriate resource 104 at the specified time in accordance with the execution instructions laid out by the job request manager 112. According to embodiments, the runtime interface 114 may be configured to communicate with the consumer system 120 via the network 140, using one or more of a variety of technologies known in the art, such as the internet, image libraries, optical networks, VPNs, and the like.

The consumer system 120 may represent any system that may be configured to utilize the resources 104 of the cloud provider system 102 to execute one or more job requests generated by the consumer system 120. The consumer system 120 may include a job list table 122, a job list manager 124, a dynamic pricing table 126, a pricing analyzer 128, a job scheduler 130, and a job run manager 132. In addition, the consumer system 120 may include various other modules, components, devices, and network interfaces that are configured to aid the consumer system 120 in utilizing the cloud provider system 102 to execute the one or more job requests.

According to embodiments, the job list table 122 may include one or more job requests. The job list table 122 may be stored on the consumer system 120 or external to the consumer system 120 as long as the job list table 122 is accessible by the consumer system 102. Additional job list table 340 illustrated in FIG. 3 is an example of a job list table similar to the job list table 122. The job list table 340 and its contents will be described in further detail during a detailed discussion of FIG. 3 below.

As described above, a job request may include any request to utilize the resources 104 of the cloud provider system 102. Examples of a job request may include storing data on a storage resource, processing information on a CPU resource, and the like. Each job request may include an identifier, a set of components, resource requirements, an amount to be paid, a deadline, and a cost-of-delay schedule. The deadline and the cost-of-delay schedule may classify the job request as one of a non-deferrable type, a deferrable type or a discretionary type. Depending upon the type of job request, the job request may be associated with a job request execution criteria that may include a set of rules under which the job request should be executed. For example, the rules may include a deadline at which the job request should start to execute, the amount of time in which the job request should be executed, the maximum cost for executing the job request, the type of resource capable of executing the job request, and the like. It should be appreciated that the job request and the job request execution criteria are generated by the consumer system 120 based on information received at the consumer system 120 from, for example, a business unit which needs a business analytics routine conducted by a particular date, a compliance entity which requires certain functionality within a given time window, or any other entity requiring the resource 104 provided by the cloud provider system 102.

As discussed above, a job request may be classified as one of three different types. For example, a job request requiring instant execution regardless of the amount to be paid for the execution may be classified as non-deferrable. A job request that may not need to start instantly but has a cost associated with the delay in executing the job request may be classified as deferrable, and a job request not associated with delay costs that may be executed at any time as long as the amount to be paid for executing the job request is below a certain amount may be classified as discretionary. It should be appreciated that both deferrable job requests and discretionary job requests may also have a deadline by which the job request should start to execute. A discretionary job may be cancelled if it does not start by the deadline.

The job list manager 124 may be configured to manage the job list table 122 as well as the job requests generated by the consumer system 120. This includes adding new job requests as they are generated by the consumer system 120, modifying existing job requests if there are changes to the job requests, and deleting job requests that have been executed or no longer require to be executed.

The consumer system 120 may also include the pricing analyzer 128 that requests, accepts, and analyzes resource pricing data from the cloud provider system 102. The pricing analyzer 128 maintains the dynamic pricing table 126 that contains the price schedules generated by the pricing manger 108. In various embodiments where the consumer system 120 may communicate with more than one cloud provider system 102, the dynamic pricing table 126 may also include information concerning the specific cloud provider system 102 from which resources are available. In addition, the pricing analyzer 128 may maintain historical pricing data for resources from the one or more cloud provider system 102, and maintain stochastic pricing models that attempt to forecast whether resource prices are likely to increase or decrease at points in the future in accordance with the dynamic pricing actions of the pricing manager 108 of the one or more cloud provider systems 102.

The consumer system 120 may further include the job scheduler 130, which may be configured to send a job request generated by the consumer system 120 to the cloud provider system 102 for execution of one or more of the resources 104 requested by the job request. The job scheduler 130 may be configured to review the data and/or price forecasts maintained by the pricing analyzer 128, in addition to the job request execution criteria associated with a job request, such as the amount to be paid, deadline, and resource requirements of the job requests as defined in the job list table 122 to determine when to send the job request to the cloud provider system 102. In particular, the job scheduler 130 may determine when to send the job request to the cloud provider system 102 based on the current price for utilizing resources of the cloud provider system, the amount and types of resources required by the job request, the type of job request including the job request's deferability, the delay cost associated with job request's deferability, and the amount to be paid for executing the job request.

Based on such determination, the job scheduler 130 may be configured to send the job request for utilizing resources of the cloud provider system 102 for immediate execution or for execution at some interval of time in the future. According to embodiments, the job scheduler 130 may send these job requests to the job request manager 112 of the cloud provider system 102. The job request manager 112 may then either accept or reject the job request based on the availability of resources at the requested time period and the amount the consumer system 120 is willing to pay to execute the job request.

In an alternative embodiment, the job scheduler 130 may provide an offer to pay a specific amount for a specific set of resources within a specific time frame to the job request manager 112. The job request manager 112 may accept the offer, reject the offer, or suggest an alternate price. If the job request manager 112 rejects the offer, the job scheduler 130 may offer a different price, or report back to the job list manager 124 that the cloud provider system 102 is unable to execute the job request based on the existing job request execution criteria.

Once the job request manager 112 accepts the job request or offer from the job scheduler 130, an order confirmation identifier is generated by the job request manager 112 according to exemplary embodiments. The order confirmation identifier may be sent to the runtime interface 114 and the job scheduler 130, which may share the order confirmation identifier with the job run manager 132 of the consumer system 120. The job run manager 132 may be configured to communicate with the runtime interface 114 of the cloud provider system 102 to execute the orders accepted by the job request manager 112. In various embodiments, the job run manager 132 may utilize the order confirmation identifier to authenticate the consumer system 120 and gain access to the one or more resources 104 chosen to execute the accepted job request.

In embodiments where the consumer system 120 is capable of utilizing the resources 104 of more than one cloud provider system 102, the job scheduler 130 may receive bids from each of the cloud provider systems 102 to execute the job requests. The job scheduler 130 may then accept the lowest price bidder and send an order to the job request manager 112 of the cloud provider system 102 that places the lowest bid. In this way, the consumer system 120 may be able to secure the lowest prices for its job requests.

Alternatively, there may be embodiments in which the cloud provider system 102 may receive job requests or offers to execute job requests from more than one consumer system. In such embodiments, the cloud provider system 102 may be able to receive job requests from multiple consumer systems and accept job requests willing to pay the highest amount for utilizing the resources of the cloud provider system 102.

The cloud provider system 102 and the consumer system 120 may communicate over the network 140. The network 140 may be a LAN, WAN, VPN, the internet or any other network that allows the cloud provider system 102 to communicate with the consumer system 120.

Referring now to FIG. 2A, a block diagram illustrating an environment 200 is shown. The environment 200 includes a matching system 250 communicating with a plurality of cloud provider systems 202A, 202B, 202C and a plurality of consumer systems 220A, 220B, 220C. In contrast to the environment 100 described in FIG. 1, where one cloud provider system 102 is communicating with one consumer system 120 over the network 140, FIGS. 2A and 2B illustrate the environment 200 that allows multiple cloud provider systems, such as the cloud provider systems 202A-202C, to execute job requests of multiple consumer systems, such as the consumer systems 220A-220C via the matching system 250. Details regarding the configuration of a cloud provider system such as the cloud provider system 202A, a consumer system such as the consumer system 220A, and the matching system 250 will be provided in regard to FIG. 2B below.

The plurality of cloud provider systems 202A-202C may communicate with the matching system 250 over the network 240A, while the plurality of consumer systems 220A-220C may communicate with the matching system 250 over the network 240B. According to embodiments, each of the networks 240A and 240B may be a LAN, WAN, VPN, the internet or any other network that allows the systems 202A-202C and 220A-220C to communicate with the matching system 250. In addition, it should be appreciated that the networks 240A and 240B may be the same network or two separate networks. In addition, each, some or all of the plurality of cloud provider systems 202A-202C and each, some or all of the plurality of consumer systems 220A-220C may communicate with the matching system 250 over separate networks or the same network. As discussed further below, the matching system 250 may receive job requests from the consumer system 220A-220C and match the job requests with the appropriate resource provided by the cloud provider system 202A-202C.

Referring now to FIG. 2B, a block diagram illustrating aspects of the matching system 250 communicating with the cloud provider system 202A and the consumer system 220A is shown. According to embodiments, the cloud provider system 202A may include one or more of the same components as the cloud provider system 102, as previously discussed.

According to embodiments, the cloud provider system 202A may include resources 204, a resource manager 206, a pricing manager 208, a pricing table 210, an order manager 212 and a runtime interface 214. In addition, the cloud provider system 202A may include a network interface (not shown) that may be configured to allow the cloud provider system 202A to communicate with the one or more consumer systems 220A-220C via the matching system 250.

The resources 204 and the resource manager 206 may be configured to be the same or similar to the resources 104 and the resource manager 106 of the cloud provider system 102 described above with respect to FIG. 1. The pricing manager 208 may also be similar to the pricing manager 108, but may be further configured to update the pricing table based, in part, on competitor pricing. Accordingly, the pricing manager 208 may be configured to receive competitor pricing information directly from the other cloud provider systems or from the matching system 250. The pricing manager 208 may analyze the received competitor pricing information to update the price schedules of the one or more resources 204 associated with the cloud provider system 202A. Other aspects of the pricing manager 208 are similar to the pricing manager 108 previously disclosed in FIG. 1.

The pricing table 210 may be similar to the pricing table 110 disclosed with regard to FIG. 1. The pricing table 210 may include price schedules for one or more of the resources 204 of the cloud provider system 202A. In addition, the pricing table 110 may be accessible by the matching system 250, such that the matching system may be able to retrieve the price schedules from the pricing table 210, which are subsequently stored in the dynamic pricing table associated with the matching system. According to exemplary embodiments, the pricing table 210 may reside within the matching system 250 instead of the cloud provider system 202A.

The cloud provider system 202A may further include the order manager 212 that may be configured to receive resource utilization orders from the matching system 250. The resource utilization orders may indicate that the resources 204 of the cloud provider system 202A match a job request of one of the consumer systems, such as the consumer system 220A. The runtime interface 214 may be configured to communicate with the matching system 250 to execute the job request at the time at which the job request is scheduled to be executed.

The consumer system 220A may be a consumer system similar to the consumer system 120 disclosed in FIG. 1. However, since the consumer system 220A is operating in the environment 200, the consumer system 220A may not include all of the components that were included in the consumer system 120. Certain components and/or functions discussed with regard to consumer system 120 may be associated with the matching system 250 in the environment 200. For instance, the consumer system 220A may not include a job run manager since the matching system 250 may be configured to perform the function of the job run manager for the consumer system 220A.

According to embodiments, the consumer system 220A may include a job list table 222, a job list manager 224, a pricing analyzer 228 and a job scheduler 230. The functionality and operation of each of these components may also differ from their respective counterparts that were included in the consumer system 120. In addition, the consumer system 220A may include a network interface (not shown) that may be configured to allow the consumer system 220A to communicate with one or more cloud provider systems 202A-202C via the matching system 250. According to embodiments, the job list manager 224 may be configured to send job requests from the job list table 222 to the matching system 250. Also, because the matching system 250 is now configured to match job requests to the resources 204 of the cloud provider system 202A, the job scheduler 230 may, instead, be utilized to update the job requests and the job request execution criteria based, in part, on the current and forecast prices for utilizing the resources 204, the execution of other job requests in the job list table 222, and the like. The pricing analyzer 228 may be configured to provide the job scheduler 230 updated current and forecasted price schedules for the various types of resources 204 accessible to the consumer system 220A. The pricing analyzer 228 may receive the updated current and forecasted price schedules for the various types of resources 204 from the matching system 250, which as described above, may retrieve the pricing table 210 from the cloud provider system 202A.

It should be appreciated that the consumer system 220A may simply be configured to send a job request to the matching system 250. The matching system 250 may receive the job request and may be configured to create a job request execution criteria associated with the job request. The matching system 250 may further be configured to match the job request received from the consumer system 220A to the appropriate resources 204 of the one or more cloud provider systems 202A-202C. In this way, many of the components of functions that may be a part of the consumer system 220A may be a part of the matching system 250.

The matching system 250 may be configured to retrieve pricing tables from the one or more cloud provider systems 202A-202C via the first network 240A. The matching system 250 may also be configured to receive job requests including the job request execution criteria from the one or more consumer systems 220A-220C over the second network 240B. Moreover, the matching system 250 may be configured to analyze the job request execution criteria for each job request, and based, in part, on the job request execution criteria and the price for utilizing the resources, match the job requests with one or more of the resources 204 of the one or more cloud provider systems 202A-202C. Upon matching a job request with one or more resources 204, the matching system 250 may send the job request to the cloud provider system 202A-202C associated with the matched resource 204 for executing the job request.

According to embodiments described herein, the matching system 250 is shown as a separate entity. However, according to various embodiments, the matching system 250 may be not be a separate entity, but rather, a part of the one or more consumer systems 220A-220C or a part of the one or more cloud provider systems 202A-202C.

The matching system 250 may include a cumulative job list table 252, a job collection module 254, a price collection module 256, a dynamic pricing table 258, a job matching module 260, and an order execution module 262. The cumulative job list table 252 may be configured to store one or more job requests and the job request execution criteria associated with each job request that is received from the consumer systems 220A-220C.

The job collection module 254 may be configured to receive one or more job requests from the corresponding job list manager 224 of the consumer systems 220A-220C. In addition, the job collection module 254 may store the job requests in the cumulative job list table 252. The job collection module 254 may also be configured to receive updates to the one or more job requests stored in the cumulative job list table 252 from the job list manager 224, including making changes to the job request execution criteria, removing a job request from the job list table, and the like.

The matching system 250 may also include the price collection module 256, which may be configured to retrieve one or more of the pricing tables 210 of the cloud provider systems 202A-202C. The price collection module 256 may further be configured to store the received pricing tables 210 in the dynamic pricing table 258 that is maintained by the price collection module 256.

The dynamic pricing table 258 may be stored in a storage device within the matching system 250 or a storage device that may reside external to the matching system 250 but accessible by the matching system 250. According to embodiments, the price collection module 256 may be configured to retrieve the pricing tables 210 of the cloud provider systems 202A-202C each time one or more pricing tables are updated. In alternative embodiments, the price collection module 256 may be configured to retrieve the pricing tables 210 from the one or more cloud provider systems 202A-202C on a periodic basis, such as once per day, hour, minute, second or any other suitable time interval.

The matching system 250 may also include the job matching module 260, which may be configured to match the one or more job requests received by the matching system 250 to the resources 204 of one or more of the cloud provider systems 202A-202C. Once a match between one or more of the resources 204 and the job request is made, the matching module 260 may further be configured to create a resource utilization order, which is then stored in a database maintained by the matching module 260, indicating which resource is matched with which job request at a particular time interval.

The matching system 250 may also include the order execution module 262 that may be configured to provide order confirmation information associated with the resource utilization order to the order manager 212 of the corresponding cloud provider system.

The order manager 212 of the corresponding cloud provider system may maintain a database that manages all the resource utilization orders to be executed by the corresponding cloud provider system. The runtime interface 214 of the corresponding cloud provider system may be configured to execute each resource utilization order by providing the order execution module 262 access to the resources 204. The order execution module 262 along with the runtime interface 214 may also be configured to forward the job request to the appropriate resources 204 of the corresponding cloud provider system for execution.

Turning now to FIG. 3, the exemplary dynamic pricing tables 300 and 320 containing price schedules and the exemplary cumulative job list table 340 containing job request entries are shown. In particular, the dynamic pricing table 300 and the dynamic pricing table 320 may be managed by the price collection module 256 of the matching system 250, while the cumulative job list table 340 may be managed by the job collection module 254.

The structure of the dynamic pricing tables 300 and 320 are identical. However, the dynamic pricing table 320 is an updated version of the dynamic pricing table 300. As described above, the price for utilizing a resource may vary based on various factors, such as the current and forecasted utilization of resources, the forecasted demand for resources, and the like. Accordingly, the dynamic pricing table 320 may include different price schedules for the same resources compared to the dynamic pricing table 300.

Rows or entries 301A, 301B, 301C, 301D in the dynamic pricing table 300 represent individual price schedules for each of the resources 204 of the one or more cloud provider systems 202A-202C in communication with the matching system 250. Each entry includes a provider system identifier 302, a resource type 304, a resource identifier 306, and one or more time intervals 308A, 308B, 308C, 308D indicating the price for utilizing the specific resource at the specified time period.

The dynamic pricing table 320 is an updated version of the dynamic pricing table 300. Accordingly, the dynamic pricing table includes the same fields or columns as the dynamic pricing table 300. However, one or more of the entries or rows 321A, 321B, 321C, 321D of the dynamic pricing table 320 may be different from the entries 301A-301D of the dynamic pricing table 300. For instance, entry 301A, which is a price schedule for server 1 of the cloud provider system 202A, was available for utilization at a price of $1 between 2PM and 3PM and $1 between 3PM and 4PM. However, the updated dynamic pricing table 320 indicates that the same resource, shown in entry 321A, is now unavailable between 2PM and 4PM.

The updated dynamic pricing table 320 now indicates server 1 as being unavailable between 2PM and 4 PM. The updated dynamic pricing table 320 further shows that the cloud provider system 202B has increased the price from $2 to $3 utilizing server 2 between 2PM and 3PM. The pricing manager of cloud provider system 202B may have updated the price schedule for server 2 to indicate the price increase upon realizing that since server 1 is unavailable, the availability of server type resources has decreased. It should also be noted that since the utilization and/or availability of the storage type resources remained unchanged, the updated price schedules may also remain unchanged. In an effort to boost utilization, the pricing managers of the cloud provider systems could have further reduced the price of utilizing the storage type resources.

FIG. 3 further illustrates the exemplary cumulative job list table 340, such as cumulative job list table 252 discussed above. The cumulative job list table 252 includes rows or job requests 341A, 341B, 341C that represent job requests and the associated job resource execution criteria. Each job request, such as the job request 341A includes a customer system identifier 342 that identifies the customer system requesting the job request, a job identifier 344 that is a unique identifier for identifying the job request, and a job request execution criteria. The job request execution criteria may include a job type 346, a list of components 348, resource requirement 350 indicating a list of resource types and the duration for which they are required, a value 352, such as an amount to be paid for utilizing the resources, and a deadline 340, indicating a deadline by which execution of the job must begin. According to embodiments, a separate column (not shown) indicating a value for the delay cost may be included in the cumulative job list table 340. As described above, the delay cost is a monetized loss that the consumer system 120 suffers for delaying the execution of the job request.

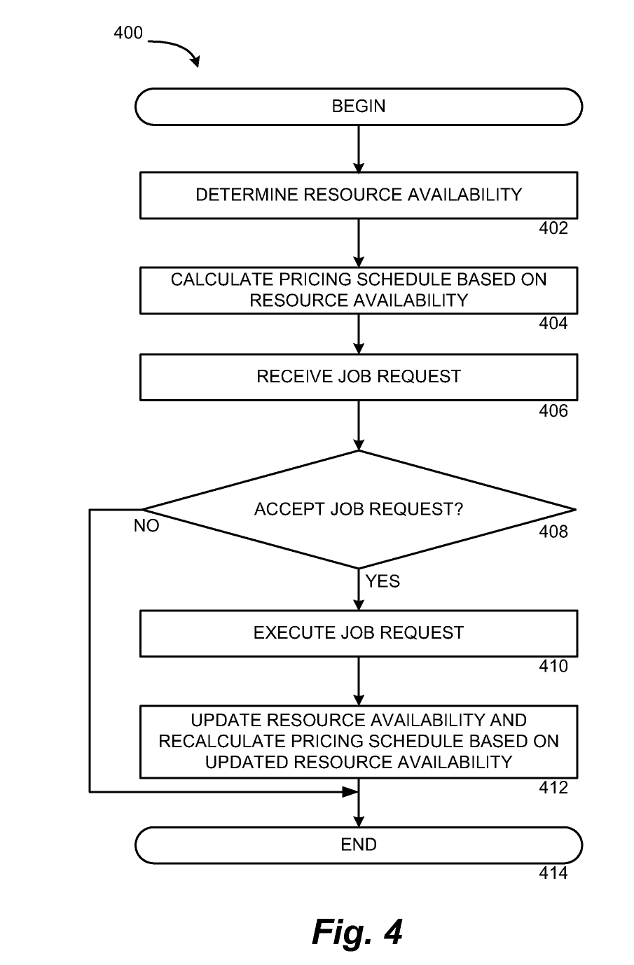

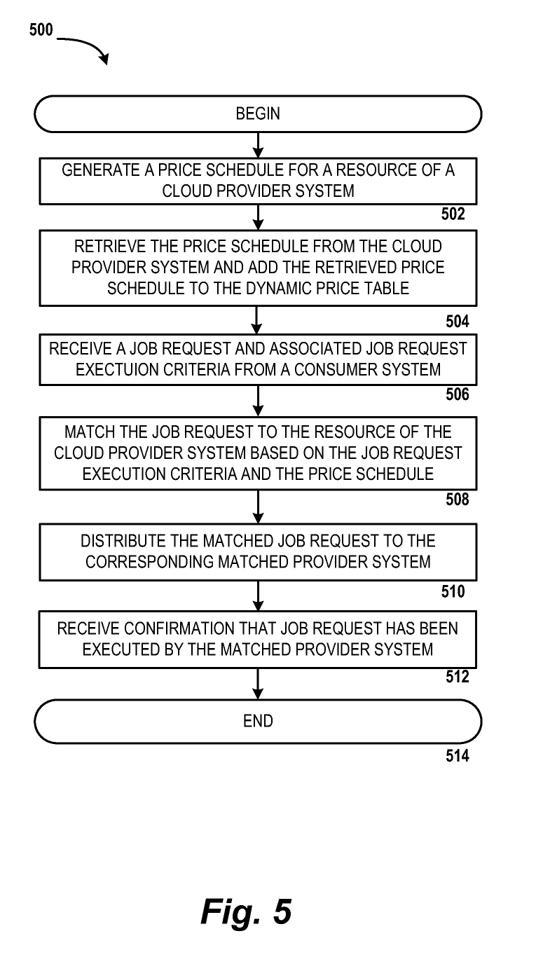

Turning now to FIGS. 4 and 5, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring now to FIG. 4, aspects of a process for creating a price schedule and executing a job request is shown. In particular, FIG. 4 is a flow diagram illustrating a routine 400 for creating a price schedule and executing a job request from the perspective of a cloud provider system such as the cloud provider system 102 in an environment where there is no matching system 250.

The routine 400 begins at operation 402, where the resource manager 106 of the cloud provider system 102 determines the current and forecasted availability of the resources 104. According to embodiments, the resource manager 106 may determine the current and forecasted availability and utilization for each of the resources 104 by analyzing existing job requests contained in the database that are being managed by the job request manager 112.

From operation 402, the routine 400 proceeds to operation 404, where the pricing manager 108 calculates the price schedules for one or more of the resources 104. The pricing manager 108 may calculate the price schedules for each of the resources 104 separately or may calculate a price schedule for each type of resource as a group. The pricing manager 108 may analyze various pieces of information to calculate the price schedules. According to one embodiment, the pricing manager 108 may calculate the price schedules based, in part, on the current and forecasted availability of the resources 104. In various embodiments, the pricing manager 108 may also analyze competitor cloud provider systems' price schedules. The pricing manager 108 may be able to retrieve this information from the dynamic pricing table 126 of the consumer system 120 or from each of the different cloud provider systems directly. In one embodiment, the cloud provider system 102 may also include a competitor price retrieving module (not shown) that may allow the cloud provider system 102 to pose as a consumer system 120 to the competitor cloud provider systems for the purpose of retrieving the price schedules of the one or more competitor cloud provider systems. It should be appreciated that the price schedules may be stored in the pricing table 110 of the cloud provider system 102, which is managed by the pricing manager 108.

From operation 404, the routine 400 proceeds to operation 406, where the cloud provider system 102 is configured to receive a job request from the consumer system 120. The job request may include a job request execution criteria, which may include the type of job request, a deadline associated with executing the job request, an amount to be paid for executing the job request and the type of resource to be utilized for executing the job request, amongst other information. According to embodiments, the job request may be sent from the job scheduler 130 of the consumer system 120. From operation 406, the routine 400 proceeds to operation 408, where the job request manager 112 determines whether to accept or reject the job request based on the job request execution criteria of the job request.

According to embodiments, if the job request manager 112 determines to reject the job request, the routine 400 proceeds from operation 408 to operation 414, where the routine 400 ends. The job request manager 112 may reject a job request if the cloud provider system is unable to match one or more of the resources 104 of the cloud provider system 102 to the job request based on the job request execution criteria. For instance, the job request manager 112 may reject the job request if there are no resources available to execute the job request or if the amount to be paid for executing the job request is lower than the price for utilizing the particular type of resource by the deadline associated with the job request.

If the job request manager 112 accepts the job request, the routine 400 proceeds from operation 408 to operation 410, where the cloud provider system 102 may be configured to execute the job request. The job request may be executed before the deadline associated with the job request.

From operation 410, the routine 400 proceeds to operation 412, where the resource manager 106 updates the resource availability and the pricing manager 108 recalculates the price schedule associated with the resources 104 based on the updated resource availability. According to embodiments, the resource manager 106 may update the resource availability each time the job request manager 112 accepts a job request. In other embodiments, the resource manager 106 may determine the resource availability once per time interval. The time interval may be any unit of time, such as days, hours, minutes, seconds and the like. From operation 412, the routine 400 ends at operation 414.

FIG. 5 is a logical flow diagram illustrating aspects of a routine 500 for matching a job request of one of the one or more consumer systems 220A-220C to one or more of the resources 204A-204C of one or more cloud provider systems 202A-202C using the matching systems 250. The routine 500 begins at operation 502, where a pricing manager, such as the pricing manager 208 of the cloud provider system 202A, generates one or more price schedules for the resources 204 and stores the generated one or more price schedules in the pricing table 210. The pricing manager 208 may generate the one or more price schedules by considering, in part, the current and forecast resource availability, historical pricing, and current and forecast pricing, of its own resources and those of competitor cloud provider systems.

From operation 502, the routine 500 proceeds to operation 504, where the price collection module 256 of the matching system 250 retrieves the corresponding pricing table 210 and adds the price schedules for each of the resources 204 contained in the pricing table 210 to the dynamic pricing table 258 of the matching system 250. The dynamic pricing table 258 may include updated price schedules for each of the resources of the cloud provider systems 202A-202C. According to embodiments, the price collection module 256 may be configured to create and update the dynamic pricing table 258 such that the matching module 260 may be configured to utilize the dynamic pricing table to match job requests to resources of the one or more cloud provider systems.

From operation 504, the routine 500 proceeds to operation 506, where the job collection module 254 of the matching system 250 receives one or more job requests from the one or more consumer systems 220A-220C. According to embodiments, the job list manager 224 of each consumer system 220A-220C may send a corresponding job list table to the job collection module 254, which stores the job requests in a cumulative job list table 252 associated with the matching system 250. Each job request includes a corresponding job request execution criteria, which may be utilized by the matching module 260 to match the job requests to one or more suitable resources of the cloud provider system 102. It should be appreciated that one or more of the consumer systems 220A-202C may simply send a job request indicating a desire to utilize one or more resources to the matching system 250. The matching system 250 may then establish the job request execution criteria for the job request. In this way, the one or more consumer systems 220A-220C may not need to include the job list table 222, the job list manager 224, the pricing analyzer 228, or even the job scheduler 230.

From operation 506, the routine 500 proceeds to operation 508, where the job matching module 260 matches job requests from the cumulative job list table 252 to the one or more of the resources 204 of the cloud provider system 202A-202C. The match is made based, in part, on the job request execution criteria, and based, in part, on the price to utilize the one or more resources 204 of the cloud provider system 202A-202C. In particular, the job matching module 260 may be configured to process each job request as the job request is received from the consumer system 220A. According to embodiments, the job matching module 260 may determine that the job request is a non-deferrable job request, a deferrable job request, or a discretionary job request. If the job request is a non-deferrable job request, the job matching module 260 may search the dynamic pricing table for the at least one resource capable of executing the job request instantly. The job matching module 260 may then identify the one or more resources 204 capable of executing the job request instantly at the lowest price.

If the job request is a deferrable type, the job matching module 260 may be configured to determine the amount to be paid for executing the job request and the deadline associated with the job request. This information may be included in the job request execution criteria associated with the job request. The job matching module 260 then searches for one or more of the resources 204 that are capable of executing the job request within the amount to be paid for executing the job request and the deadline associated with the job request. The job matching module 260 may then identify the one or more resources capable of executing the job request within the deadline and at a lowest price below the amount to be paid for executing the job request.

If the job request is a discretionary type, the job matching module 260 may be configured to determine the amount to be paid for executing the job request. Once the job matching module 260 determines this, the job matching module 260 searches for the one or more of the resources 204 capable of executing the job request within the amount to be paid for executing the job request. The job matching module 260 may then identify the one or more resources 204 capable of executing the job request at a lowest price below the amount to be paid for executing the job request. Once the job matching module 260 identifies the one or more resources that are capable of executing the job request based on the job request execution criteria, the job matching module 260 matches the identified one or more resources 204 to the job request based, in part, on the job request execution criteria and based, in part, on the price of the one or more resources 204 capable of executing the job request.

From operation 508, the routine 500 continues to operation 510, where the order execution module 262 of the matching system 250 distributes the matched job request to the matched cloud provider system 202A for execution. According to embodiments, the order execution module 262 may coordinate with the runtime interface 214 of the matched cloud provider system 202A. In this way, the runtime interface 214 may be configured to receive the job request from the order execution module 262 at the scheduled time for executing the job request.

From operation 510, the routine 500 proceeds to operation 512, where the matching system 250 receives confirmation from the matched cloud provider system 202A that the job request has been executed. This may be an explicit confirmation message sent to the matching system 250. From operation 512, the routine 500 ends at operation 514.

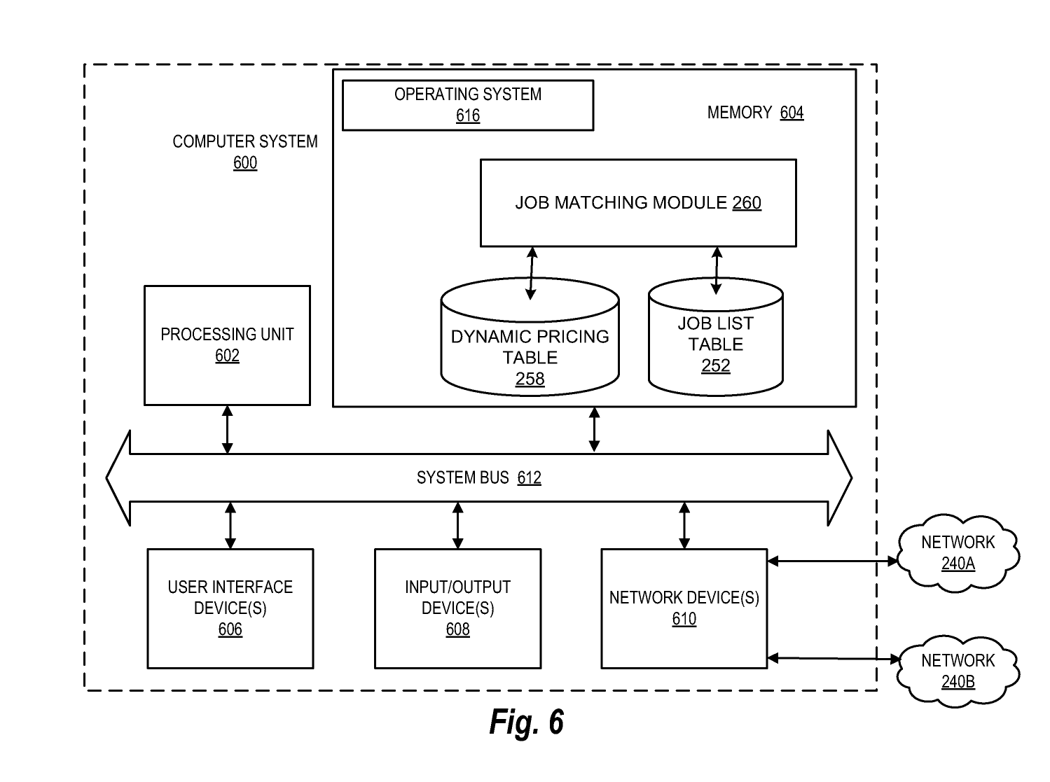

FIG. 6 is a block diagram illustrating a computer system 600 configured to optimize the utilization of a resource of a cloud service provider based on variable pricing strategies, in accordance with embodiments. Examples of the computer system 600 may include a system that includes one or more of the cloud provider system 102, 202A-202C, the consumer system 120, 220A-220C and the matching system 250. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 604 communicates with the processing unit 602 via the system bus 612. In one embodiment, the memory 604 is operatively connected to a memory controller (not shown) that enables communication with the processing unit 602 via the system bus 612. The memory 604 includes an operating system 616 and one or more modules of the matching system 250, such as the job matching module 260, and the dynamic pricing table 258 and the cumulative job list table 252, according to exemplary embodiments. Examples of operating systems, such as the operating system 616, include, but are not limited to, WINDOWS, WINDOWS CE, and WINDOWS MOBILE from MICROSOFT CORPORATION, LINUX, SYMBIAN from SYMBIAN LIMITED, BREW from QUALCOMM CORPORATION, MAC OS from APPLE CORPORATION, and FREEBSD operating system. In some embodiments, the one or more modules of the matching system 250 are embodied in computer-readable media containing instructions that, when executed by the processing unit 602, performs embodiments of the routine 500 for optimizing the utilization of resources of a cloud provider system, as described in greater detail above with respect to FIG. 5. According to embodiments, the one or more modules of the matching system 250 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600.

The user interface devices 606 may include one or more devices with which a user accesses the computer system 600. The user interface devices 608 may include, but are not limited to, computers, servers, personal digital assistants, cellular phones, or any suitable computing devices. The I/O devices 608 enable a user to interface with the program modules 618. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via the networks 240A and 204B. Examples of the network devices 610 may include, but are not limited to, a modem, a radio frequency (“RF”) or infrared (“IR”) transceiver, a telephonic interface, a bridge, a router, or a network card. The networks 240A and 240B may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 620 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A computer-implemented method for optimizing utilization of a resource of a cloud service provider, the method comprising:
receiving a time-based price schedule associated with the resource of the cloud service provider, the time-based price schedule comprising a price for utilizing the resource during at least one time period;
receiving a job request with associated job request execution criteria;
based on the job request execution criteria and the price for utilizing the resource during the at least one time period, matching the job request with the resource; and
sending the job request matched with the resource to the cloud service provider of the resource for execution.

2. The computer-implemented method of claim 1, wherein the job request execution criteria comprises at least one of an amount to be paid for executing the job request, a type of job request, a deadline associated with the job request, and the type of resource required to execute the job request.

3. The computer-implemented method of claim 2, wherein the type of job request comprises a non-deferrable type, a deferrable type, and a discretionary type.

4. The computer-implemented method of claim 3, wherein matching the job request with the resource based on the job request execution criteria and the price for utilizing the resource during the at least one time period comprises:
determining that the job request is the non-deferrable type;
upon determining that the job request is the non-deferrable type, searching for the resource capable of executing the job request instantly; and
identifying the resource capable of executing the job request instantly at a lowest price.

5. The computer-implemented method of claim 3, wherein matching the job request with the resource based on the job request execution criteria and the price for utilizing the resource during the at least one time period comprises:
determining that the job request is the deferrable type;
upon determining that the job request is the deferrable type, determining the amount to be paid for executing the job request and the deadline associated with the job request;
upon determining the amount to be paid for executing the job request and the deadline associated with the job request, searching for the resource capable of executing the job request within the amount to be paid for executing the job request and the deadline associated with the job request; and
identifying the resource capable of executing the job request within the deadline and at a lowest price below the amount to be paid for executing the job request.

6. The computer-implemented method of claim 3, wherein matching the job request with the resource based on the job request execution criteria and the price for utilizing the resource during the at least one time period comprises:
determining that the job request is the discretionary type;
upon determining that the job request is the discretionary type, determining the amount to be paid for executing the job request;
upon determining the amount to be paid for executing the job request, searching for the resource capable of executing the job request within the amount to be paid for executing the job request; and
identifying the resource capable of executing the job request at a lowest price below the amount to be paid for executing the job request.

7. The computer-implemented method of claim 1, further comprising:
maintaining a job request table comprising the job request; and
updating the job request table to indicate that the job request has been matched to the resource at a specific time period.

8. The computer-implemented method of claim 7, further comprising:
receiving a notification from the at least one cloud service provider that the at least one job request has been executed; and
upon receiving the notification that the job request has been executed, updating the job request table to indicate that the at least one job request has been executed.

9. The computer-implemented method of claim 1, further comprising receiving updates to the time-based price schedule associated with the resource based, at least in part, on availability of the resource.

10. The computer-implemented method of claim 9, wherein the updates to the time-based price schedule associated with the resource are received upon matching the job request to the resource.

11. A system for optimizing utilization of resources of a plurality of cloud service providers, comprising:
a memory storing a program for optimizing the utilization of resources of a plurality of cloud service providers; and
a processor functionally coupled to the memory, the processor being responsive to computer-executable instructions contained in the program and configured to:
receive a pricing table from a cloud service provider of the plurality of cloud service providers, the pricing table comprising a time-based price schedule associated with the price of utilizing a resource of the cloud service provider,
create a dynamic pricing table using the pricing table received from the cloud service provider,
receive a job request from a consumer of a plurality of consumers, the job request comprising a job request execution criteria,
match the job request to the resource of the cloud service provider using the dynamic pricing table and the job request execution criteria of the job request, and
send the matched job request to the resource of the cloud service provider for execution.

12. The system of claim 11, wherein the dynamic pricing table comprises at least one entry, the at least one entry configured to include identification and time-based pricing information for the resource matched to execute the job request.

13. The system of claim 11, wherein the job request execution criteria comprises at least one of a cost of executing the at least one job request, a type of job request, a deadline associated with the at least one job request, and the type of resource required to execute the job request.

14. The system of claim 11, wherein the dynamic pricing table from the cloud service provider is received over a network.

15. The system of claim 11, wherein the processor being responsive to further computer-executable instructions contained in the program and configured to update the dynamic pricing table upon receiving an updated pricing table from the cloud service provider.

16. A computer-readable storage medium for optimizing utilization of a resource of a cloud service provider, having computer-executable instructions stored thereon that when executed by a computer, causes the computer to:
receive a time-based price schedule associated with the resource of the cloud service provider, the time-based price schedule comprising a price for utilizing the resource during at least one time period;
receive a job request with associated job request execution criteria;
based on the job request execution criteria and the price for utilizing the resource during the at least one time period, match the job request with the resource; and
send the job request matched with the resource to the cloud service provider of the resource for execution.

17. The computer-readable storage medium of claim 16, wherein the job request execution criteria comprises at least one of an amount to be paid for executing the job request, a type of job request, a deadline associated with the job request, and the type of resource required to execute the job request.

18. The computer-readable storage medium of claim 16, having computer-executable instructions stored thereon that when executed by a computer, causes the computer to:
determine that the job request is one of a non-deferrable type, deferrable type and a discretionary type;
if the job request is the non-deferrable type:
search for a resource capable of executing the job request instantly, and
identify the resource capable of executing the job request instantly at a lowest price,
if the job request is the deferrable type:
determine the amount to be paid for executing the job request and a deadline associated with the job request,
upon determining the amount to be paid for executing the job request and the deadline associated with the job request, search for a resource capable of executing the job request within the amount to be paid for executing the job request and the deadline associated with the job request, and
identify the resource capable of executing the job request within the deadline and at a lowest price below the amount to be paid for executing the job request, and
if the job request is the discretionary type:
determine the amount to be paid for executing the job request,
upon determining the amount to be paid for executing the job request, search for a resource capable of executing the job request within the amount to be paid for executing the job request, and
identify the resource capable of executing the job request at a lowest price below the amount to be paid for executing the job request.

19. The computer-readable storage medium of claim 16, having further computer-executable instructions stored thereon that when executed by a computer, causes the computer to:
maintain a job request table comprising the job request; and
update the job request table to indicate that the job request has been matched to the resource at a specific time period.

20. The computer-readable storage medium of claim 16, having further computer-executable instructions stored thereon that when executed by a computer, causes the computer to receive updates to the time-based price schedule associated with the resource upon matching the job request to the resource.
